(19) United States
(12) Patent Application Publication
(10) Pub. No.: US 2026/0316250 A1
(43) Pub. Date: Oct. 15, 2026

(54) Switch assembly, switch assembly control method and electric tool

(71) Applicant: Hilti Aktiengesellschaft, Schaan (LI)

(72) Inventor: Thomas KIONTKE, Lichtenberg (DE)

(21) Appl. No.: 19/108,573

(22) PCT Filed: Sep. 1, 2023
(86) PCT No.: PCT/EP2023/074087

§ 371 Date: Mar. 4, 2025

(30) Foreign Application Priority Data
Sep. 14, 2022 (EP) 22195539.6

(51) Int. Cl. B25F 5/02; H01H 3/20

(52) U.S. Cl. CPC B25F 5/02; H01H 3/20

(57) ABSTRACT

A switch assembly control method, the switch assembly including a housing, a main switch accommodated in the housing, and a safety lock and a trigger which are mounted on the housing, the safety lock being moveable between a locked position and an unlocked position, and the safety lock blocking the trigger when located at the unlocked position such that the main switch will not switch on; when the safety lock is located at the locked position, the main switch activates a “hold to run” mode when the trigger is triggered and moved through a first travel; and the main switch activates a “constant on” mode when the trigger is moved through a second travel.

### TECHNICAL FIELD

The present invention relates to an electric tool, in particular to a switch assembly for an electric tool, a control method of switch assembly, and an electric tool having the switch assembly.

### BACKGROUND ART

Electric tools, in particular thermal tools such as heat guns, can be operated by a user in two different modes, depending on the applications. One mode is “hold-to-run” mode: the tool will start up if an activation switch (or trigger) is pressed, and shut off when the activation switch is released. This mode is suitable when using the tool for short periods of time. The other mode is “constant on” mode: if the user performs a certain action such as locking the activation switch (or trigger), the tool will keep running as continuous operation. This mode is suitable for hands-free use or when using the tool for a long period of time. If there is no “constant on” mode, then hands-free operation will not be possible. This will limit the applications of the thermal tool.

### SUMMARY OF THE INVENTION

To meet the demand for electric tools to implement both of the modes mentioned above, existing solutions generally rely on an additional control element, such as a trigger lock (as is already known in amateur drilling machines) or even an additional locking device. However, the additional control element merely locks the “hold to run” activation switch in the ON position. Mechanical control elements need to be operated to switch from one operating mode to another operating mode, and this adds an additional cost and effort. Furthermore, additional parts and necessary movements in dusty jobsite conditions can cause failures and can result in hazardous situations. In addition, in most cases, existing solutions are only optimized for right-handed users; this relates to the issue of ergonomics, restricting equal use by left-and right-handed users.

In view of the above, there is a need to improve to an existing switch assembly and an electric tool assembled with the switch assembly, in order to solve the abovementioned problems.

It is an object of the present invention to provide a switch assembly for an electric tool, a control method of switch assembly, and an electric tool having the switch assembly, to control two operating modes in a simple and reliable manner and prevent unintended switch on.

To solve the abovementioned technical problem, the technical solution of the present invention is as follows:

A control method of switch assembly for an electric tool, the switch assembly being connected to an electronic control unit of the electric tool, the switch assembly comprising a main switch accommodated in a housing of the electric tool and further comprising a safety lock and a trigger which are mounted on the housing, the safety lock being moveable between a locked position and an unlocked position, and the safety lock blocking the trigger when located at the locked position such that the main switch will not switch on; when the safety lock is located at the unlocked position, the main switch activates a “hold to run” mode when the trigger is triggered and moved through a first travel; and the main switch activates a “constant on” mode when the trigger is moved through a second travel. Thus, by means of a switch assembly combined with the two operating modes “hold to run” and “constant on”, and by controlling the triggering and movement travel of the trigger, the present invention achieves switching between the two operating modes in a simple and reliable manner, and the safety lock prevents accidental activation.

According to an embodiment of the present invention, when the main switch activates the “hold to run” mode, the safety lock stays at the unlocked position, and the trigger stays at a position where it has been moved within the first travel; when the trigger is released, the main switch switches off, and the electric tool stops working. Thus, in the “hold to run” mode, the trigger needs to be pressed continuously; if it is released, the main switch immediately switches off.

According to an embodiment of the present invention, when the main switch activates the “constant on” mode, the trigger is released back to its initial position and the safety lock moves back to the locked position. In the “constant on” mode, the user does not need to continue gripping the electric tool, which keeps running in a hands-free state, greatly improving the convenience of operation.

According to an embodiment of the present invention, if the trigger is triggered again and moved through a third travel, the main switch switches off, ending the “constant on” mode. If the electric tool is running in the “constant on” mode, the user needs to press the trigger again to switch it off. To avoid having to press the safety lock in order to switch off the tool, a certain travel distance (third travel) is left between the trigger and the safety lock, so the safety lock does not need to be pressed. This travel distance is only used for switching off the tool from the “constant on” mode.

According to an embodiment of the present invention, the main switch is designed as a potentiometer having discrete or continuous travel distances, the travel distances of the potentiometer correspond to the first travel, second travel and/or third travel of movement of the trigger, and the electronic control unit calculates and determines the activation and switching of tool operating modes by means of signals of the potentiometer. With such a configuration, it is possible to realize at least 2 operating modes (“hold to run” and “constant on”) by allocating these to certain trigger positions, no need of an additional control component, thus reducing sensitivity to dust/dirt.

According to an embodiment of the present invention, the first travel is less than the second travel; and the third travel is less than the first travel. The different operating modes are switched by assessing the different travel distances of movement the trigger.

According to an embodiment of the present invention, when the trigger is moved past the first travel, a feedback signal is provided to identify that the main switch is switching from the “hold to run” mode to the “constant on” mode. The feedback signal comprises any one or a combination of a haptic, acoustic or optical signal. The feedback signal helps the user to identify the switching of operating modes, to avoid erroneous operation.

The present invention also provides a switch assembly for an electric tool, the switch assembly being connected to an electronic control unit of the electric tool, and comprising a main switch accommodated in a housing of the electric tool and further comprising a safety lock and a trigger which are mounted on the housing, the switch assembly being designed to perform the switch assembly control method described above.

According to an embodiment of the present invention, the safety lock is mounted at a back side of the housing, and comprises a pressing part exposed above the housing, a resisting part that resists the trigger, and a rotating part connecting the pressing part and the resisting part.

According to an embodiment of the present invention, when the safety lock is at the locked position, the resisting part and a contacting part of the trigger have a gap of maximum distance of the third travel. If the tool is running in the “constant on” mode, the user needs to press the trigger again to switch it off. To avoid having to press the safety lock in order to switch off the tool, a certain movement distance needs to be left between the trigger and the safety lock, so the safety lock does not need to be pressed. This movement distance, i.e. the distance of the third travel, is only used for switching off the tool from the “constant on” mode. Within this travel distance, the tool is not permitted to switch on, because the safety lock does not cover this travel distance.

According to an embodiment of the present invention, an additional force step is provided between the main switch and the trigger, the spring is compressed when the trigger is moved past the first travel, and a greater pressure than in the first travel is required for the trigger to be further moved through the second travel. To enable the user recognition of the trigger travel distance and with this to enable the user to differentiate between the two operation modes, an additional recognizable force step (e.g. an additional spring on the switch rod) is used. The additional force step shall be engaged at the same trigger travel distance on which the constant-on mode is triggered, and this gives the user haptic feedback.

According to another embodiment of the present invention, a sensor for detecting a trigger movement distance is provided between the main switch and the trigger, and when the trigger is moved past the first travel, the sensor sends a signal to the electronic control unit of the electric tool to identify that the main switch is switching from the “hold to run” mode to the “constant on” mode. In this way, the sensor can identify a change between the two modes, and can give the user acoustic (click or buzz) or optical (flash, light, indicator light) feedback.

In addition, the present invention further provides an electric tool, comprising the switch assembly described above, and an electronic control unit coupled to the switch assembly, to control the switching of an electric tool on or off. The two operating modes of the electric tool—“hold to run” and “constant on”—are realized by the switch assembly control method described above.

The electric tool is a thermal tool, in particular a heat gun. Certain specific application scenarios of thermal tools, especially heat guns, require continuous operation. In these cases, hands-free functionality is especially important; the thermal tool is fixed to a support, the “constant on” mode is activated, and the tool operates continuously without the need for the user to hold it in his hand, thus greatly increasing the thermal tool application scenarios as well as convenience.

### BRIEF DESCRIPTION OF THE DRAWINGS

The embodiments mentioned can be better understood through the following detailed description while the drawings are read. It is emphasized that the various components are not necessarily drawn to scale. In fact, dimensions can be enlarged or reduced at will for the purpose of clear discussion. In the drawings, the same reference numerals refer to the same elements.

FIG. 1 shows a schematic drawing of a switch assembly according to an exemplary embodiment of the present invention.

### DETAILED DESCRIPTION

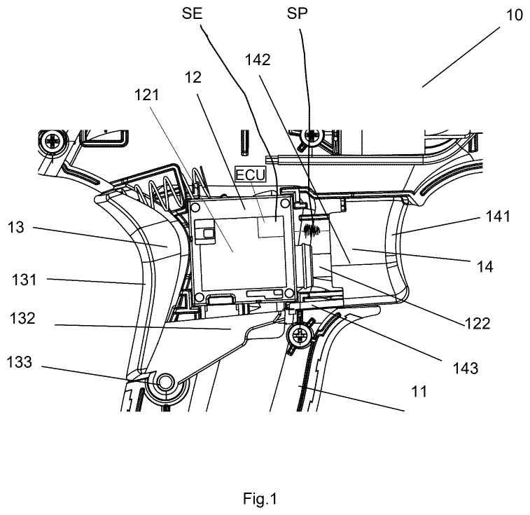

A switch assembly for an electric tool, a switch assembly control method, and an electric tool with the switch assembly according to embodiments of the present invention are described below with reference to FIG. 1.

The electric tool of the present invention may be a thermal tool, a blower, etc., in particular a heat gun, but not limited to a thermal tool.

As an exemplary embodiment of the present invention, the electric tool is a heat gun. The heat gun comprises a housing, a heating unit, a fan unit, a battery unit, an electronic control unit ECU shown solely schematically and a switch assembly 10. An air outlet for discharging heated air is provided on one end of the housing. The fan unit has an electric motor and at least one fan propeller capable of being driven by means of the electric motor. The air flow generate from the fan unit is heated by the heating unit. The control unit effects an appropriate control of the heating unit and fan unit. The battery unit is mounted to the bottom of the housing 11 in a known manner. The switch assembly 10 is used to switch on or shut down the electric tool. In view of other units or components of the electric tool of the present invention are known, the following section of this specification will mainly describe in detail the specific structure and activation method of the switch assembly 10.

FIG. 1 shows a partial schematic drawing of a handle part of the electric tool, with the switch assembly fitted to the handle part. The housing 11 is partially shown as a handle of the electric tool. Typically, the switch assembly 10 is mounted on the handle, where it can be operated most conveniently. The switch assembly 10 comprises a main switch 12 accommodated in the housing 11, as well as a safety lock 13 and a trigger 14 which are mounted on the housing 11.

The safety lock 13 of the present invention is mounted at a back side of the handle, and comprises a pressing part 131 exposed above the housing 11, a resisting part 132 that contacts (resists) the trigger 14, and a rotating part 133 connecting the pressing part 131 and the resisting part 132. The pressing part 131 has a profile that roughly matches an outside surface of the handle, and the pressing part 131 is exposed outside the housing 11, for a user to press manually. The rotating part 133 is mounted on a support structure in the housing 11, such that the rotating part 133 is able to shift and rotate relative to the housing 11; thus, when the pressing part 131 is pressed, the resisting part 132 can be synchronously driven to rotate.

The safety lock 13 has a locked position and an unlocked position. As long as the pressing part 131 of the safety lock 13 is not pressed, the safety lock 13 is located in the locked position; the safety lock is disposed opposite the trigger 14 and restricts the action of the trigger 14, the trigger 14 is locked, the main switch 12 cannot switch on, and hence the electric tool cannot operate, thus preventing the electric tool from being started up accidentally. When the user grips the electric tool by the handle, the pressing part 131 will be pressed naturally, and through this action, the safety lock 13 moves to the unlocked position, no longer obstructing the trigger 14. When the safety lock 13 is located at the unlocked position, the safety lock 13 is located not opposite to the trigger 14 and the restricting relationship therebetween is removed; the trigger 14 is unlocked, the main switch 12 can switch on, and if the trigger 14 is pressed at this time, the main switch 12 switches on, the electric tool starts to operate, and the electric tool preforms normal operation.

It should be noted that when the safety lock 13 is located at the locked position, a gap of a specific distance, i.e. the maximum distance of a third travel of the trigger 14, is left between the resisting part 132 and the trigger 14, for the purpose of switching off the main switch in the “constant on” mode of the electric tool, and thereby switching off the electric tool. This function is described in further detail below.

Refer to FIG. 1, the main switch 12 comprises a body part 121 and an extending/retracting arm 122 connected to the body part 121; the extending/retracting arm 122 is configured to be elastic, in order to be able to return to its original position automatically when pressure is released. In one embodiment of the present invention, the main switch 12 is a potentiometer, configured to measure and determine a triggering position and movement distance of the trigger 14. This measurement of movement distance may be discrete and/or continuous.

The trigger 14 comprises a triggering part 141 exposed below the housing 11, a connecting part 142 connected to the main switch 12, and a contacting part 143 that can contact the resisting part 132 of the safety lock. When not triggered, the trigger 14 is located at its initial position; when the user presses the triggering part 141, the whole of the trigger 14 moves towards the safety lock, on condition that the safety lock 13 is located at the unlocked position.

Preferably, an additional force step such as a spring SP shown solely schematically is also provided between the main switch 12 and the trigger 14; when the trigger 14 is moved past a first travel, the spring is compressed, and a greater pressure than in the first travel is required for the trigger 14 to be further moved through a second travel. Therefore, when the “hold to run” mode switches to the “constant on” mode, a larger force is needed for the user to press and move the trigger 14, thus making the user aware of the change in operating mode.

According to another embodiment of the present invention, a sensor (not shown solely schematically as SE) for detecting the travel distance of the trigger is provided between the main switch 12 and the trigger 14; when the trigger is moved past the first travel, the sensor sends a signal to the electronic control unit ECU of the electric tool to identify that the main switch is switching from the “hold to run” mode to the “constant on” mode. In this way, the sensor can identify a change between the two modes, and can give the user acoustic (e.g., click or buzz) or optical (e.g., flash, light, indicator light) feedback. In other embodiments, a feedback unit may also be integrated in the electronic control unit of the electric tool. Alternatively, the sensor can (not must) be the main switch itself, since the main switch is a potentiometer.

The control method of switch assembly the present invention is described in detail below.

Firstly, when the electric tool is not being used, the safety lock 13 is located at the locked position; at this time, because the safety lock 13 is blocking the trigger 14 and the main switch 12, pressing the trigger 14 cannot make the trigger 14 move, so the main switch 12 will not switch on.

When the user grips the handle of the electric tool, the user can easily press the safety lock 13 to make it rotate from the locked position to the unlocked position because the pressing part 131 of the safety lock is at the back side of the handle; a finger of the user presses the triggering part 141 of the trigger 14, and the trigger 14 begins to move; the user presses the triggering part 141 continuously until the trigger 14 has moved through a first travel, e.g. 4 mm, and the extending/retracting arm 122 of the main switch has moved through the distance of the first travel, e.g. 4 mm, pushed by the connecting part 142 of the trigger. At this time, the potentiometer that is the main switch measures that the extending/retracting arm has moved through the distance of the first travel, and determines activation of the “hold to run” mode; the electric tool begins to work, and the electric tool begins to operate normally. In the “hold to run” operating mode, the user needs to grip the handle of the electric tool continuously, i.e., the safety lock 13 is at the unlocked position, while the trigger 14 is held at the position where it has moved within the first travel. If the trigger 14 is released, the main switch will switch off. This mode is suitable when using the tool for short periods of time, or is suitable for scenarios in which specific operations are required from the user.

However, for thermal tools, especially heat guns, it is sometimes necessary to work on a workpiece for a long time, e.g., supply hot air to a frozen duct for a long time to melt the frozen part. In such applications, a hands-free function is advantageous, as it can free both hands of the user, reducing the user's labour intensity and tiredness. The implementation of a hands-free function requires an electric tool to have a “constant on” operating mode: if the user performs a certain action, such as locking an activation switch (or trigger), the tool will enter a state of continuous operation; the user does not need to grip the electric tool, which will keep running until the user performs another action, to switch off this operating mode. This mode is suitable for hands-free use or when using the tool for a long period of time. If there is no “constant on” mode, then hands-free operation will not be possible. This will limit the applications of the thermal tool.

To avoid accidental start-up of the electric tool, which would cause unnecessary danger, the trigger can only be triggered when the safety lock of the electric tool is pressed to the unlocked position; thus, the electric tool always starts up in the “hold to run” mode first. Once the “hold to run” mode has been activated, if the user wishes to switch to the “constant on” mode, he continues to press the trigger 14 to make it move through a second travel distance, e.g. 8 mm. The control unit measures the distance of the second travel, and determines activation of the “constant on” mode. Then the user can release the trigger 14; the trigger 14 returns to the initial position, but the electric tool continues to run. Even if the user no longer grips the handle, releasing the trigger 14 and the safety lock 13 at the same time, with the trigger 14 returning to the initial position and the safety lock 13 returning to the locked position, the electric tool will continue running.

Furthermore, to allow the user to clearly identify when the electric tool has switched from the “hold to run” mode to the “constant on” mode, a feedback signal is provided to the user to make him aware of the mode change when the trigger 14 is pressed past the first travel, e.g. 4 mm. The feedback signal may be haptic, acoustic (e.g. click or buzz), and/or optical (e.g. flash, light, indicator light), etc. Preferably, as shown in FIG. 1, an additional force step such as a spring is provided between the main control switch 12 and the trigger 14. The spring begins to be compressed at the position where the trigger has been moved through the first travel; due to the rebound force of the spring, moving the trigger further to the position of the second travel will require a larger pressure than when the trigger is in the first travel, so the user can sense the activation of the “constant on” mode directly by touch.

When the electric tool is running in the “constant on” mode, it is highly likely to be in a hands-free state, e.g. the tool is fixed to a support and performing an operation on a specific workpiece. When the electric tool has completed the designated work and needs to be switched off, the user does not need to grasp the handle of the tool again, but simply needs to touch the trigger 14 lightly, to move the trigger 14 through the distance of the third travel, e.g. 2 mm; the main switch 12 will immediately switch off, and the electric tool will stop running. The distance of the third travel mentioned here means the gap distance between the resisting part 132 of the safety lock 13 and the contacting part 143 of the trigger 14 when the safety lock 13 is located at the locked position. Thus, in the “constant on” mode, the user does not need to press the safety lock 13 again to make it rotate to the unlocked position, but merely needs to press the trigger to move through the third travel, e.g. 2 mm, and can thereby switch off the main switch and the electric tool in a simple manner. However, if the electric tool is not in the “constant on” operating mode, if the user presses the trigger and move the trigger 14 through the 3^{rd} travel (2 mm), the electric tool would not be switched on.

In the present invention, the first travel, second travel or third travel through which the trigger 14 is moved is set by the potentiometer of the main switch, and different travel distances can be defined according to the structure and requirements of different electric tools; for example, in the embodiment above, the first travel distance is 4 mm, the second travel distance is 8 mm, and the third travel distance is 2 mm. Alternatively, the first travel distance is 3-5 mm, the second travel distance is 6-8 mm, and the third travel distance is 1.5-2.5 mm. In the embodiment above, the path along which the trigger 14 is moved is unique, i.e. whether it is moved through the first, second or third travel, in each case the triggering part is pressed, and the trigger 14 moves in a straight line towards the safety lock. Thus, the first travel should be less than the distance of the second travel, and the distance of the third travel should be less than the distance of the first travel. Herein, any travel distances are all counted from the zero or initial position.

According to an alternative embodiment, the trigger may instead have different movement paths, e.g. trigger rotation directions or trigger movement positions, and correspondingly, the first travel, second travel and third travel respectively correspond to travels or positions of rotation or movement of the trigger.

In the switch assembly for an electric tool and control method thereof according to the present invention, and the electric tool having the switch assembly, switching and control of at least two operating modes (“hold to run” and “constant on”) can be achieved through different travels of the trigger. There is no need for an additional mechanical control component; the user simply needs to grasp the handle in order to control the positions of the safety lock and trigger, and thereby distinguish and switch between the two operating modes in a visually direct manner, enabling hands-free use. Moreover, with both left and right hands available, convenience of operation is increased.

As mentioned above, although exemplary embodiments of the present invention have been explained herein with reference to the drawings, the present invention is not limited to the specific implementations above, and may have many other implementations. The scope of the present invention should be defined by the claims and their equivalent meanings.

What is claimed is:

1 to 15. (canceled)

16. A control method for switch assembly for an electric tool, the switch assembly being connected to an electronic control unit of the electric tool, the switch assembly including a main switch accommodated in a housing of the electric tool and further comprising a safety lock and a trigger mounted on the housing, the safety lock being moveable between a locked position and an unlocked position, and the safety lock blocking the trigger when located at the locked position such that the main switch will not switch on, the control method comprising:
triggering the trigger and moving the trigger through a first travel when the safety lock is located at the unlocked position to activate a hold to run mode via the main switch; and
moving the trigger through a second travel to activate a constant on mode via the main switch.

17. The control method as recited in claim 16 wherein when the main switch activates the hold to run mode, the safety lock stays at the unlocked position, and the trigger stays at a position where the trigger has been moved within the first travel; and when the trigger is released, the main switch switches off.

18. The control method as recited in claim 17 wherein when the main switch activates the constant on mode, the trigger is released and the safety lock moves back to the locked position.

19. The control method as recited in claim 18 wherein when the trigger is triggered again and moved through a third travel, the main switch switches off, ending the constant on mode.

20. The control method as recited in claim 19 wherein the first travel is less than the second travel; and the third travel is less than the first travel.

21. The control method as recited in claim 16 wherein the main switch is designed as a potentiometer with discrete or continuous value steps measureable by the electronic control unit to determine a switch travel distance.

22. The control method as recited in claim 21 wherein when the trigger is moved past the first travel, a feedback signal is provided to identify that the main switch is switching from the hold to run mode to the constant on mode.

23. The control method as recited in claim 22 wherein the feedback signal comprises any one or combination of a haptic, acoustic or optical signal.

24. A switch assembly connected to an electronic control unit of an electric tool, the switch assembly comprising:
a main switch accommodated in a housing of the electric tool;
a safety lock; and
a trigger mounted on the housing of the electric tool, the safety lock being moveable between a locked position and an unlocked position, and the safety lock blocking the trigger when located at the locked position such that the main switch will not switch on, and
when the safety lock is located at the unlocked position, the main switch is configured to activate a hold to run mode when the trigger is triggered and moved through a first travel; and the main switch is configured to activate a constant on mode when the trigger is moved through a second travel.

25. The switch assembly as recited in claim 24 wherein the safety lock is mounted at a back side of the housing, and includes a pressing part exposed above the housing, a resisting part resisting the trigger, and a rotating part connecting the pressing part and the resisting part.

26. The switch assembly as recited in claim 25 wherein when the safety lock is at the locked position, the resisting part and another end of the trigger have a gap of maximum distance of a third travel.

27. The switch assembly as recited in claim 26 further comprising a spring between the main switch and the trigger, the spring being compressed when the trigger is moved past the first travel, and a greater pressure than in the first travel is required for the trigger to be further moved through the second travel.

28. The switch assembly as recited in claim 26 further comprising a sensor for detecting a trigger movement distance between the main switch and the trigger, and when the trigger is moved past the first travel, the sensor sends a signal to the electronic control unit of the electric tool to identify that the main switch is switching from the hold to run mode to the constant on mode.

29. An electric tool comprising the switch assembly as recited in claim 24 and the electronic control unit coupled to the switch assembly.

30. The electric tool as recited in claim 29 wherein the electric tool is a thermal tool.

31. The electric tool as recited in claim 29 wherein the electric tool is a heat gun.
